(19) United States
(12) Patent Application Publication
(10) Pub. No.: US 2004/0233491 A1
(43) Pub. Date: Nov. 25, 2004

(54) Scanning device with emitting and receiving scanner prisms mounted on common rotating shaft

(76) Inventors: Holger Schanz, Lindau (DE); Wilfried Mehr, Lindau (DE); Udo Baumann, Eschbronn (DE); Fritz Schmider, Hornberg (DE)

Correspondence Address: FASSE PATENT ATTORNEYS, P.A., P.O. BOX 726, HAMPDEN, ME, 04444-0726, US

(21) Appl. No.: 10/788,888

(22) Filed: Feb. 27, 2004

Related U.S. Application Data
(63) Continuation-in-part of application No. PCT/DE02/03027, filed on Aug. 9, 2002.

(30) Foreign Application Priority Data
Aug. 31, 2001 (DE) 101 42 458.2
Sep. 7, 2001 (DE) 101 44 130.4

(51) Int. Cl. G02B 26/08

(52) U.S. Cl. 359/196

(57) ABSTRACT

An optical scanning apparatus includes a radiation source that emits a radiation beam, a rotating first prism that deflects the emitted beam, a first lens that projects the deflected emitted beam onto a scene to be scanned, a second lens that receives a reflected beam arising as a reflection of the emitted beam from the scene and projects the reflected beam onto a rotating second prism, which deflects the reflected beam onto a photodetector. The first and second prisms are respectively rigidly mounted on or connected to a common rotatable drive axle, preferably on two opposite ends of the drive axle, which is preferably a rotor shaft of a drive motor. Thereby, the rotation of the two deflection prisms is positively and precisely synchronized, and the overall apparatus is compact, simple and robust. This apparatus is suitable for use in an optical distance radar system for a motor vehicle.

### CROSS-REFERENCE TO RELATED APPLICATION

This application is a Continuation-In-Part under 35 U.S.C. §111(a) and §120 of PCT International Application PCT/DE02/03027, filed on Aug. 9, 2002, which designated the United States, and which was published in a language other than English. The entire disclosure of that PCT International Application is incorporated herein by reference.

### PRIORITY CLAIM

Through the above identified PCT International Application, this application is based on and claims the priorities under 35 U.S.C. §119 of German Patent Applications 101 42 458.2 filed on Aug. 31, 2001, and 101 44 130.4 filed on Sep. 7, 2001. The entire disclosures of the German Priority Applications are incorporated herein by reference.

### FIELD OF THE INVENTION

The invention relates to a scanning device with a deflection prism on the emitting end to deflect a light beam onto a scene to be scanned and a deflection prism on the receiving end to deflect a reflection beam resulting as a reflection of the light beam from the scene.

### BACKGROUND INFORMATION

A scanning device of the above mentioned general kind has been disclosed, for instance, by the German Patent publication DE 41 15 747 C2. The disclosed device comprises three plane-parallel deflection prisms, which are each individually rotated around their own respective driving axle. The first of these deflection prisms is located in the beam path of a light beam that is emitted onto a scene as well as in the beam path of a reflection beam that results as a reflection of the light beam from the scene. This first prism is rotated around a vertical driving axle and thus effects a horizontal deflection of the light beam and of the reflection beam. In this connection, the deflection results from the refraction of the light entering into and emerging from the deflection prism. The other two deflection prisms are respectively individually located in the beam path of the light beam or of the reflection beam, respectively. These prisms are rotated synchronously with each other, respectively around two horizontal driving axles that are parallel to each other. By means of light refraction, these two prisms effect a vertical deflection of the light beam or the reflection beam, respectively. Here, the synchronization of the respective rotating movements of the several prisms is assured by a complex and expensive drive arrangement with toothed gears and an associated toothed belt.

### SUMMARY OF THE INVENTION

It is an object of the invention to provide a scanning apparatus with a first deflection prism on the emitting end to deflect a light beam emitted onto a scene to be scanned, and a second deflection prism on the receiving end to deflect a reflection beam resulting as a reflection of the light beam from the scene, which apparatus has a simple and economical construction, and ensures a precise positively-enforced synchronization of the rotation of the prisms. The invention further aims to avoid or overcome the disadvantages of the prior art, and to achieve additional advantages, as apparent from the present specification. The attainment of these objects is, however, not a required limitation of the invention.

The above objects have been achieved according to the invention in an optical scanning apparatus having the above mentioned general structure, wherein the two deflection prisms are each rigidly connected to a single common driving axle, e.g. preferably respectively on two axle arms of the driving axle, which is rotatably supported. Advantageous embodiments and further improvements of the invention are defined in the appended claims.

The scanning apparatus or device according to the invention comprises a first deflection prism in an emitting arrangement to deflect a light beam emitted onto a scene to be scanned, a second deflection prism in a receiving arrangement to deflect a reflection beam resulting as a reflection of the light beam from the scene, and a rotatable driving axle. In this context, the deflection prisms are each rigidly connected to the common driving axle, e.g. respectively to a respective axle arm of the driving axle. Thus, by rotation of the driving axle, the two prism are rotated synchronously with each other. A good signal separation between the emitting and the receiving end is achieved by the structural separation of the deflection prisms along the driving axle, e.g. at opposite ends of the driving axle.

In an advantageous further improvement, the driving axle is embodied as a rotor axle of a motor and is thus driven directly by the motor. The motor body of the motor, including a stator and a rotor, may be located between the two prisms, which are respectively mounted on the two opposite ends of the rotor axle that protrude in opposite directions from opposite sides of the motor body.

The deflection prisms are preferably made of a material that is transparent to the light beam and the reflection beam. The deflection of the light beam by the first deflection prism on the emitting end and of the reflection beam by the second deflection prism on the receiving end is preferably effected by total internal reflection of the respective beam in the interior of the respective deflection prism.

Preferably, a respective lens arrangement or device for focusing the light beam or the reflection beam is respectively arranged between the respective associated deflection prism and the scene to be scanned.

Furthermore, a radiation source for emitting the light beam and a photodetector for detecting the reflection beam resulting from the light beam are preferably provided. The radiation source is positioned in relation to the first deflection prism on the emitting end and the photodetector is positioned in relation to the second deflection prism on the receiving end, in such a manner so that the reflection beam impinges on the photodetector. Advantageously, the radiation source is embodied as a laser diode.

The scanning device according to the invention is most suitable for use in an optical distance radar for motor vehicles. With such an application, the scanning device is used for signal detection.

### BRIEF DESCRIPTION OF THE DRAWINGS

Further advantages and details of the invention will become apparent from the ensuing description of an example embodiment of the invention taken in conjunction with the drawings, wherein:

FIG. 1 is a schematic diagram of the scanning apparatus according to the invention; and

FIG. 2 is a sectional drawing of a motor of the scanning apparatus according to FIG. 1.

### DETAILED DESCRIPTION OF A PREFERRED EXAMPLE EMBODIMENT AND THE BEST MODE OF THE INVENTION

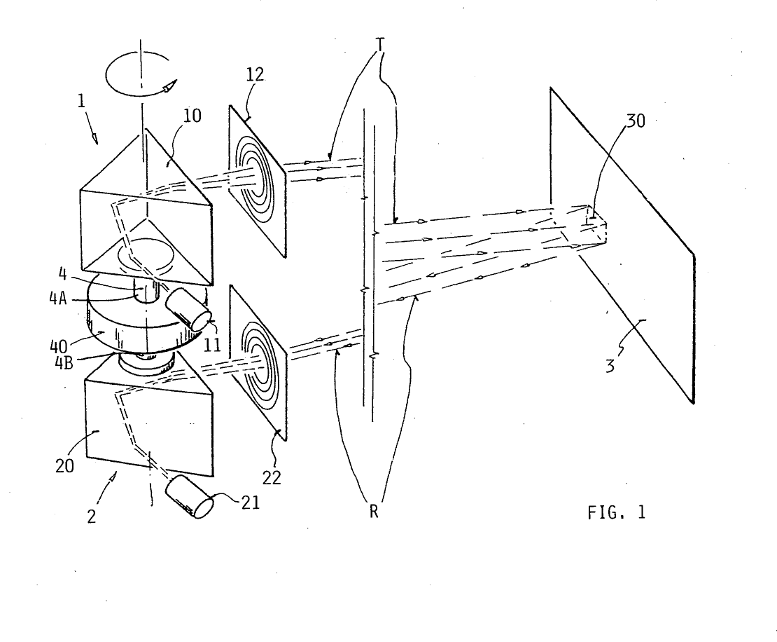

According to FIG. 1, the scanning apparatus or device according to the invention comprises an emitter 1 including a radiation source 11 that is embodied for instance as an infrared laser diode, a first deflection prism 10 having a triangular cross-section, and a first lens device 12 embodied as a Fresnel lens. Further, the scanning device comprises a receiver 2, which is constructed generally analogously to the emitter 1. Thus, the receiver 2 comprises a second deflection prism 20 corresponding to the first deflection prism 10, and a second lens device 22 corresponding to the first lens device 12 of the emitter 1. Here, the deflection prisms 10, 20 and the lens devices 12, 22 are each identically embodied. The difference between the emitter 1 and the receiver 2 is that, instead of the radiation source 11, the receiver 2 comprises a photodetector 21 embodied for instance as a PIN-diode.

Furthermore, the scanning apparatus or device comprises a motor embodied as an electric motor 40 with a rotor axle, which acts as a driving axle 4 for rotationally driving the deflection prisms 10, 20. The first deflection prism 10 is rigidly connected on one axle arm 4A of the driving axle 4, and the second deflection prism 20 is rigidly connected on the opposite axle arm 4B of the driving axle 4. For this purpose, the driving axle 4 further comprises a respective mounting or receiving plate for receiving the respective deflection prisms 10, 20 respectively on the two opposite axle arms 4A and 4B. The deflection prisms 10, 20 are rotated synchronously with each other by the electric motor 40. By means of the structural separation of the two prisms 10, 20 from each other with the motor 40 therebetween, a good channel separation between the emitter 1 and the receiver 2 is achieved.

The electric motor 40 is preferably an electronically commutated d.c. motor. This assures a high running smoothness of the entire arrangement during operation, so that the scanning device is suitable for installation in a motor vehicle cabin.

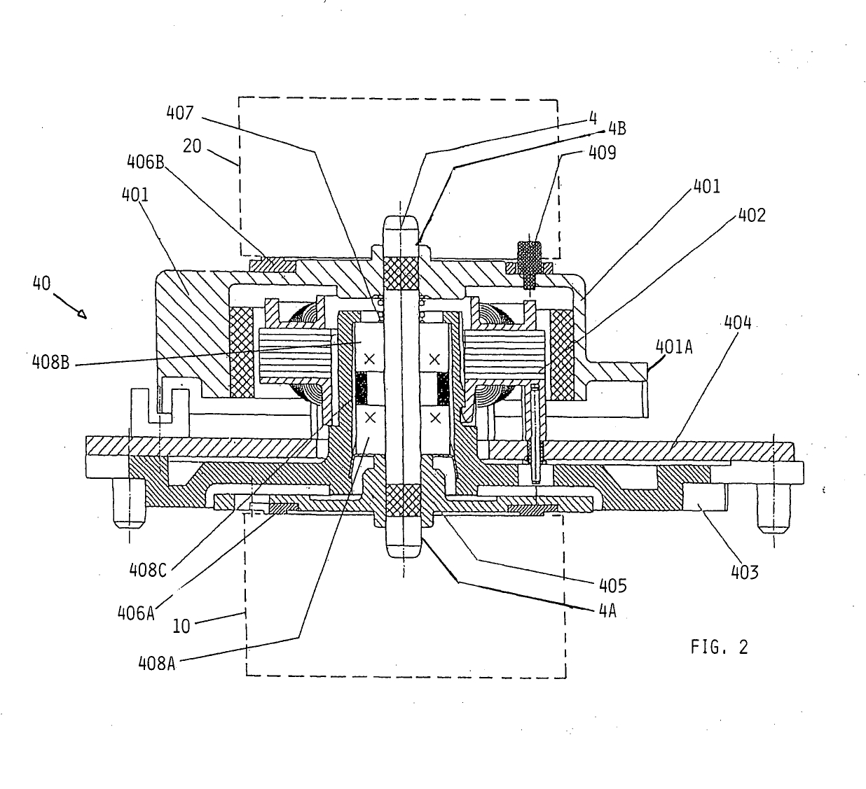

According to FIG. 2 the electric motor 40 is embodied as an external rotor motor. Thus, it comprises a permanent magnetic rotor 401, which is rigidly connected with the driving axle 4 on one side thereof, and which surrounds a stator 402 rigidly connected with a motor bracket or base plate 403. The stator 402 comprises several windings, which are supplied with current in cyclic order and in dependence on the relative position of the rotor 401 via a motor controller printed circuit board 404. The outer edge 401A of the rotor 401 acts as an indicator disc with position indicator indicia, which makes it possible to detect the relative position of the rotor 401.

The rotor 401 comprises a contact support or rest 406B, onto which is placed the deflection prism 20 (shown by broken lines). Thus, a portion of the rotor 401 itself serves as a receiver plate for receiving the deflection prism 20. The rotor 401 further comprises a rotational fixing or positioning pin 409 that acts as a rotational driver dog or carrier and reaches into a corresponding positioning hole provided in the deflection prism 20. Thus, the deflection prism 20 is rigidly connected with one end or arm 4B of the driving axle 4 via the rest 406 and the rotor 401, so that the prism 20 rotates positively fixedly with the rotor 401 and the axle 4. On the opposite end or arm 4A of the driving axle 4, a receiver plate 405 is rigidly connected with this end of the driving axle 4. The receiver plate 405 further similarly cooperates with a contact support or rest 406A. The deflection prism 10 (shown by broken lines) is rigidly connected via this rest 406A with the receiver plate 405 and thus to the driving axle 4. Thereby, the prism 10 rotates positively fixedly with the plate 405 and the axle 4.

The base plate 403 comprises a bearing suspension tube, which is provided to receive two bearings 408A, 408B kept at distance apart from each other by a bearing bush 408C. The bearings 408A, 408B are provided to rotatably support or bear the driving axle 4. The driving axle 4 and the rotor 401 are held by a spring 407 in a stable axial position. The described type of bearing is advantageous as the driving axle 4 can thereby be embodied with a rather short overall length, and thus the unit made up of the deflection prisms 10, 20, the driving axle 4 and the motor 40 is very rigid and less susceptible to vibrations.

High synchronism of the electric motor 40 is particularly advantageous for operation. This is achieved by means of a three-phase winding structure, a large centrifugal mass as well as a shape of the stator sheets which is optimized to small jerk moments. The actual speed output is effected with very low variations six times per revolution by means of a sensorless three-phase motor driver. In a further drive embodiment, a high polar tachometer generator is used for detecting the actual speed. To this end, the motor controller printed circuit board 404 is provided with a meander-shaped winding and the rotor magnet is high-polar magnetized on the end face thereof.

From a position which is fixed in relation to the deflection prism 10 and the lens device 12, the radiation source 11 emits a light beam T toward the deflection prism 10 during the scanning process. The deflection prism 10 is embodied to be transparent to the light of the radiation source 11, so that the light beam T penetrates into the deflection prism 10, is deflected by total internal reflection in the deflection prism 10 on one of its side walls, and subsequently reemerges from the deflection prism 10. When penetrating into and emerging from the deflection prism 10, the light beam T is refracted, if applicable under the respective existing conditions (angles, refractive index, etc.). After its emersion, the deflected light beam T is projected via the lens device 12 on a scene 3 to be scanned. The radiation source 11 thus illuminates a defined region 30 of the scene 3. By the rotation of the deflection prism 10, the internal angle of reflection of the light beam T changes in the deflection prism 10. Thereby, the light beam T is moved or scanned over the scene 3 in a direction across or perpendicular to the driving axle 4, which means in a horizontal direction in the present embodiment.

In relation to the second deflection prism 20 in the receiver 2, the photodetector 21 is positioned so that part of the light beam T, which in the region 30 is reflected from an object of the scene 3 to form a reflection beam R, is focused onto the photodetector 21 as a reflection beam R via the lens device 22 and the deflection prism 20, which is transparent to the reflection beam R. Just as was the case for the light beam T in the first deflection prism 10, here, the reflection beam R is deflected by total reflection in the deflection prism 20. The deflection angles, by which the light beam T and the reflection beam R are deflected, are identical to each other in magnitude and respectively each change by identical values due to the rotation of the deflection prisms 10, 20. Thereby, the defined region 30 illuminated by the light beam T is scanned across the scene 3 in synchronism with the location from which the receiver 2 receives reflected light as the reflection beam R and deflects it onto the photodetector 21. In other words, at all times, the emitter 1 and the receiver 2 are both synchronously trained on the same moving spot or region 30 on the scene 3.

In the present embodiment the deflection prisms 10, 20 comprise side faces that are all are aligned or oriented parallel to the driving axle 4. However, the prisms may alternatively comprise side faces that are inclined at different angles in relation to the driving axle 4. Thereby, a scanning deflection or excursion of the light beam T in a direction along or parallel to the driving axle 4 is additionally achieved, which means a vertical scanning deflection or excursion in the present example embodiment. The amount or angle of the vertical deflection depends on the respective tilt angle of the individual side face of the prism from which the beam is being internally reflected. Scene 3 is thereby scanned in several successive partially overlapping horizontal lines.

By evaluation of the signal transit time of the signal emitted as light beam T and received as reflection beam R, the distance between the scanning device and the location 30 in the scene 3, on which the light beam T is reflected, can be determined. This is pertinent information for a motor vehicle spacing distance radar system or the like. Therefore, the inventive scanning apparatus is most suitable for use in a system for supporting or assisting the driver of a motor vehicle, in particular in a spacing distance regulating system for a motor vehicle or in a system for the recognition of objects in the surroundings of a vehicle. With an application of this type, the surroundings of a vehicle are scanned by means of the scanning apparatus and the received reflection signal is analyzed in order to recognize objects, in particular vehicles driving ahead of the subject vehicle in which the system is installed, and to detect the distances to these objects. On the basis of these detected distances, it is then verified whether the safe spacing distance from a preceding vehicle is being maintained. If not, the system can determine whether a warning signal shall be given to the driver, if necessary, or whether the spacing distance from the preceding vehicle shall be automatically regulated (e.g. by automatically reducing the driving speed at least temporarily).

With the inventive scanning apparatus, it is also possible to scan the roadway region on the sides of the vehicle to recognize road markings provided to demarcate the lanes on the roadway, and to warn the driver when the vehicle is straying from the lane or even to enable an automatic lane maintaining operation.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. An optical scanning apparatus for optically scanning a scene, comprising:
an emitting arrangement including a first prism arranged and adapted to deflect a light beam on an emitted beam path emitted to the scene;
a receiving arrangement including a second prism arranged and adapted to deflect a reflection beam on a received beam path received from the scene as a reflected portion of said light beam that is reflected from the scene; and
a drive axle that is rotatably supported;
wherein said first prism and said second prism are both respectively rigidly connected in common to said drive axle, so that said drive axle, said first prism and said second prism are rotatable in common as a unit.

2. The optical scanning apparatus according to claim 1, wherein said drive axle includes two axle arms, said first prism is rigidly mounted on a first one of said axle arms, and said second prism is rigidly mounted on a second one of said axle arms.

3. The optical scanning apparatus according to claim 2, wherein said drive axle has opposite first and second terminal ends, said first axle arm includes and terminates at said first terminal end, said second axle arm includes and terminates at said second terminal end, said first prism is mounted on said first terminal end, and said second prism is mounted on said second terminal end.

4. The optical scanning apparatus according to claim 3, further comprising a motor body, wherein said drive axle forms a rotor axle cooperating with and protruding from said motor body.

5. The optical scanning apparatus according to claim 4, wherein said first and second axle arms respectively protrude in opposite directions from opposite sides of said motor body, and said motor body is located between said first and second prisms.

6. The optical scanning apparatus according to claim 1, further comprising a motor body, wherein said drive axle forms a rotor axle cooperating with and protruding from said motor body, and said drive axle and said motor body together form a motor.

7. The optical scanning apparatus according to claim 6, wherein said drive axle is a single one-piece axle.

8. The optical scanning apparatus according to claim 6, wherein said drive axle establishes a direct-drive connection, without any intervening transmission mechanism, to said first and second prisms which are rigidly connected thereto.

9. The optical scanning apparatus according to claim 6, wherein said motor is an electronically commutated, multi-phase d.c. motor.

10. The optical scanning apparatus according to claim 6, wherein said motor body comprises an internal stator and an external rotor that is rigidly connected to or integral with said drive axle.

11. The optical scanning apparatus according to claim 10, wherein said external rotor includes an outer rotor rim provided with position indicator indicia that indicate a rotational position of said rotor.

12. The optical scanning apparatus according to claim 6, wherein a selected one of said prisms is fixedly secured to said rotor, which forms a mounting plate therefor.

13. The optical scanning apparatus according to claim 12, further comprising a positioning pin that protrudes from said rotor into a positioning hole provided in said selected one of said prisms, so as to fix a rotational alignment between said rotor and said selected one of said prisms.

14. The optical scanning apparatus according to claim 6, further comprising a mounting plate that is rigidly connected to said drive axle, wherein one of said prisms is fixedly secured to said mounting plate so as to rotate therewith.

15. The optical scanning apparatus according to claim 6, wherein said motor includes a fixed non-rotatable stator, a rotor rigidly connected to said shaft, a motor bracket which fixedly carries said stator and by which said motor can be fixedly mounted in said apparatus, and a bearing arrangement that rotatably supports said drive axle relative to said motor bracket.

16. The optical scanning apparatus according to claim 15, wherein said stator comprises a motor coil with a three-phase winding.

17. The optical scanning apparatus according to claim 1, wherein said first and second prisms are respectively transparent to the light beam and the reflection beam.

18. The optical scanning apparatus according to claim 1, wherein:
said emitting arrangement further includes a first lens arrangement interposed in said emitted beam path between said first prism and the scene; and
said receiving arrangement further includes a second lens arrangement interposed in said received beam path between the scene and said second prism.

19. The optical scanning apparatus according to claim 1, wherein:
said emitting arrangement further includes a radiation source adapted to emit the light beam;
said receiving arrangement further includes a photodetector adapted to detect the reflection beam; and
said radiation source is positioned relative to said first prism and said photodetector is positioned relative to said second prism so that the reflection beam impinges onto the photodetector.

20. The optical scanning apparatus according to claim 19, wherein said radiation source is positioned relative to said first prism and said photodetector is positioned relative to said second prism so that the light beam is deflected by total internal reflection in said first prism, the reflection beam is deflected by total internal reflection in said second prism, and a rotating of said first and second prisms scans the light beam and the resulting reflection beam across the scene.

21. The optical scanning apparatus according to claim 19, wherein said radiation source comprises a laser diode.

22. An optical distance radar system for a motor vehicle incorporating the optical scanning apparatus according to claim 1.

23. An optical scanning apparatus for optically scanning a scene, comprising:
a radiation source adapted to emit a light beam;
a first prism arranged to receive and deflect the light beam to the scene;
a second prism arranged to receive and deflect a reflection beam formed as a portion of the light beam reflected from the scene;
a photodetector arranged to receive the reflection beam that is deflected by said second prism; and
a drive motor comprising a stator, a rotatable rotor, and a rotatable drive shaft connected rigidly to said rotor;
wherein said first and second prisms are both connected rigidly to said drive shaft along a single rotation axis common to both of said first and second prisms.

24. The optical scanning apparatus according to claim 23, wherein said drive shaft protrudes in two opposite directions from two opposite sides of said rotor, and said rotor and said stator are arranged between said first and second prisms.
